(19) United States
(12) Patent Application Publication
(10) Pub. No.: US 2012/0166943 A1
(43) Pub. Date: Jun. 28, 2012

(54) ELECTRONIC DEVICE HAVING PAGE DIVISION DISPLAY FUNCTION AND PAGE DISPLAY METHOD

(75) Inventors: HUI-LING HUANG, Shenzhen City (CN); XIAO-GUANG LI, Shenzhen City (CN); HONG-YE LIU, Shenzhen City (CN); XIAO-LE LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/118,474

(22) Filed: May 30, 2011

(30) Foreign Application Priority Data
Dec. 25, 2010 (CN) 201010605441.6

(51) Int. Cl. G06F 17/00

(52) U.S. Cl. 715/273

(57) ABSTRACT

An electronic device which comprises a storage unit to store files and a division information table, an input unit generating input signals in response to user input operations, a display unit displaying information, and a processing unit controlling the electronic device to enter into a reading mode, controlling the display unit to a page of a file, determining whether the page has a portrait layout or a horizontal layout according to the properties of the page, dividing the page into a plurality of blocks according to a division information table, controlling the display unit to display all the blocks thereon, and displaying a selected block of the page with a magnified display size according to an input signal from the user. A page display method is also provided.

### BACKGROUND

1. Technical Field

The present disclosure relates to electronic devices and screen display methods and, particularly, to an electronic device having page division display function and a page display method applied on the electronic device.

2. Description of the Related Art

When a user reads a file using a conventional handheld mobile device, characters or pictures of the file displayed on the device are frequently difficult to read due to the small screen size. Accordingly, the user must continuously press a direction button or manipulate the scroll bars or touch screen to enlarge a portion of the contents of the file, which is very inconvenient and may cause fatigue in the user.

### BRIEF DESCRIPTION OF THE DRAWINGS

The components of the drawings are not necessarily drawn to scale, the emphasis instead being placed upon clearly illustrating the principles of an electronic device having a page division display function and a page display method thereof. Moreover, in the drawings, like reference numerals designate corresponding parts throughout multiple views.

FIG. 1 is a schematic view of an electronic device showing a page divided into nine blocks in accordance with an exemplary embodiment.

FIG. 2 is a schematic view of the electronic device of FIG. 1 showing one of the nine blocks enlarged separately.

FIG. 3 is a block diagram of the hardware of the electronic device of FIG. 1.

FIG. 4 is a schematic view of a portrait page, the portrait page having been divided into nine blocks.

FIG. 5 is a schematic view of a horizontal page, the horizontal page having been divided into nine blocks.

FIG. 6 is a flowchart of a page display method applied in the electronic device of FIG. 1.

FIG. 7 is a flowchart of a file reading method of FIG. 6.

### DETAILED DESCRIPTION

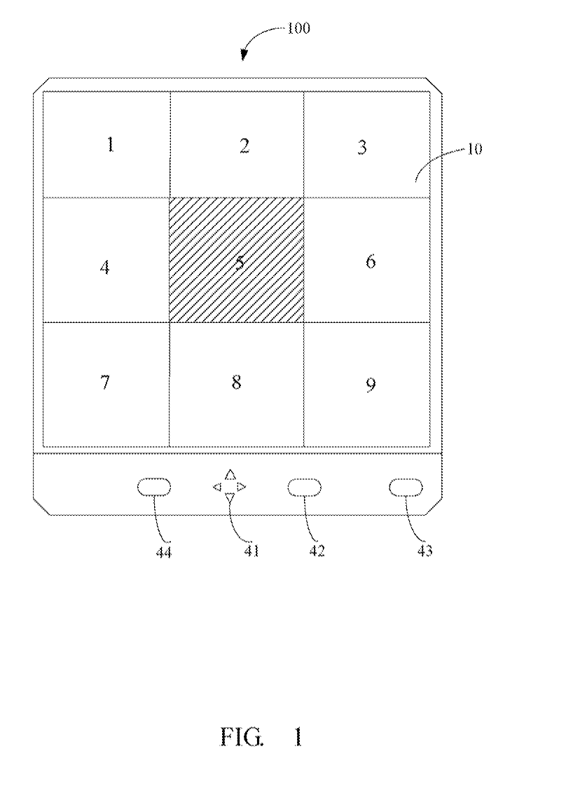

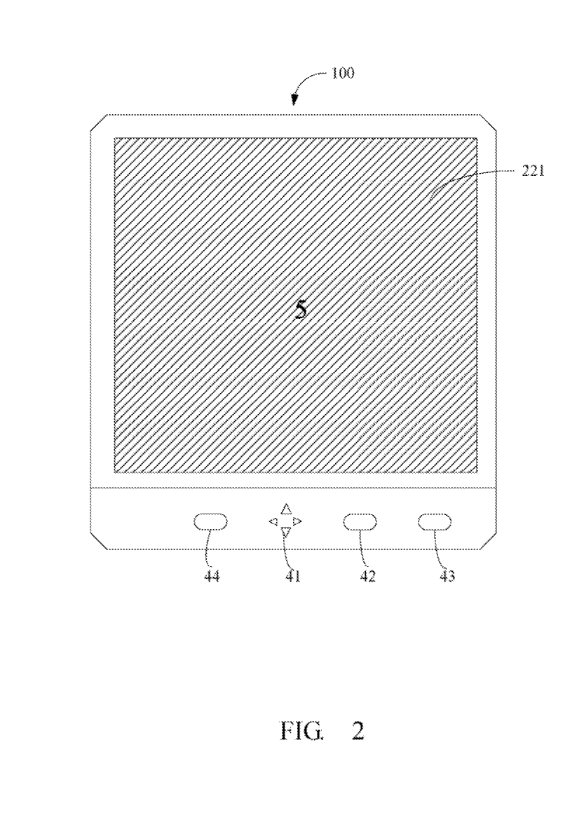

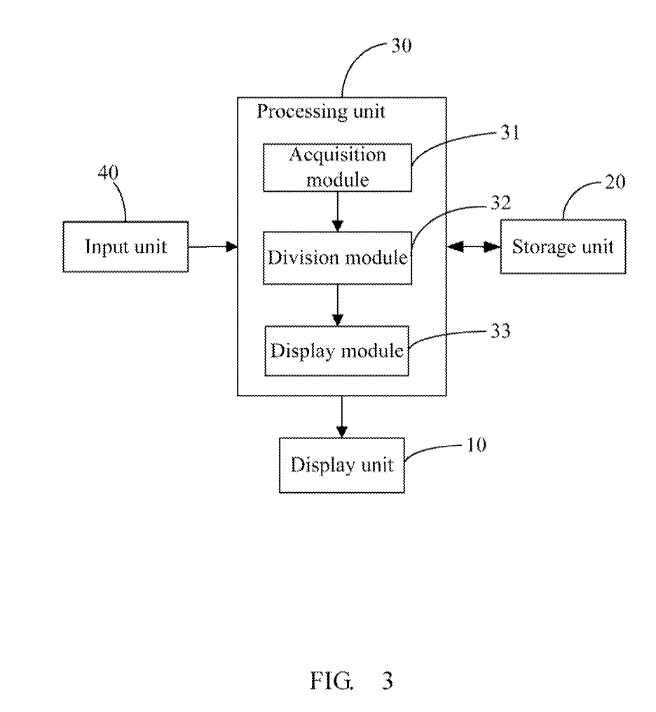

Referring to FIGS. 1-3, an electronic device 100 includes a display unit 10, a storage unit 20, a processing unit 30, and an input unit 40. The storage unit 20 stores electronic files to be displayed on a screen window of the display unit 10 for users to read. The processing unit 30 is configured to read a page of a selected file and divide the page into a plurality of blocks 221. Each block 221 can be enlarged independent from other blocks 221 and displayed on the screen window by the processing unit 30, such that the block will have sufficient size and the contents of the block can be easily read.

The storage unit 20 also stores a division information table, the division information table includes information defining the number of blocks that a page needs to be divided into, and the size and position of each block after division.

The input unit 10 is for receiving input operations. The input unit 40 may be one or more buttons, a mouse or a touch panel. In the embodiment, the input unit 40 includes a direction button 41, a confirm button 42, a return button 43 and a menu button 44. In an embodiment, the direction button 41 is a four-way button for controlling a controllable object such as a cursor to move up, down, left or right. In an alternative embodiment, the direction button 41 is a two-way button for controlling a controllable object in only two directions. The confirm button 42 confirms an operation. The return button 43 returns the electronic device 100 to a previous state from the current state. The menu button 44 is for commanding the electronic device 100 to display all options available to the user.

In the embodiment, the processing unit 30 includes an acquisition module 31 a division module 32, and a display module 33. After the user has selected reading mode via the menu button 44, the acquisition module 31 reads a file list and the display module 33 displays the file list listing one or more files. Generally, the files are presented by icons or their titles on the display unit 10. The acquisition module 31 is for receiving inputs from the direction button 41, and moving a cursor among the files in response to the input of the direction button 41. The acquisition module 31 reads a particular page of a file selected by the cursor according to a confirm signal from the confirm button 42. The particular page read by the acquisition module may be the first page of the file or any other page according to a default set up in the electronic device 100.

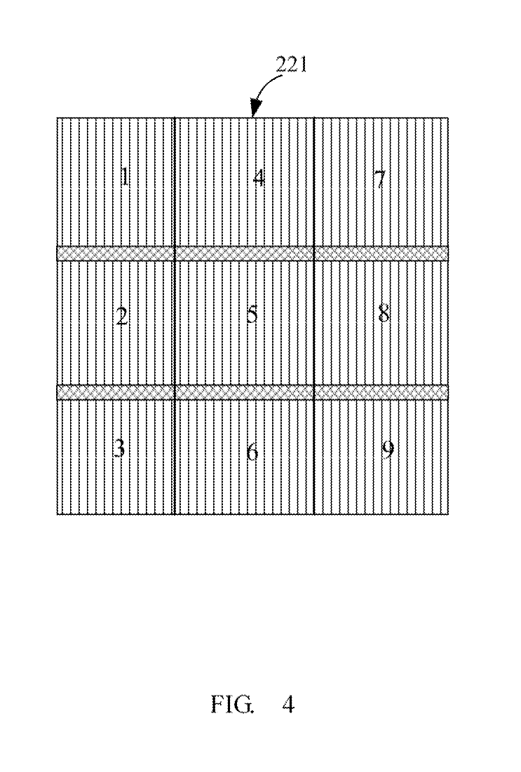

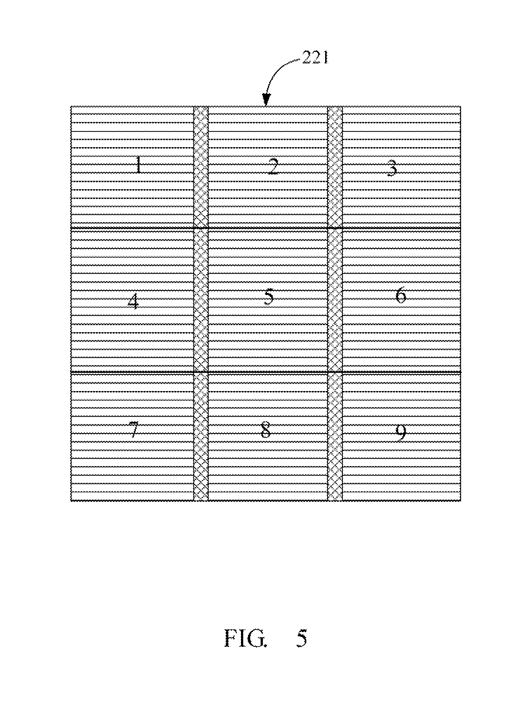

The division module 32 searches the storage unit 20 for the division information table. If no division information table is stored, the division module 32 is for displaying the complete page on the display unit 10. If a division information table is found, the division module 32 further is configured for determining the page format according to the properties of the page, and dividing the page into a number of blocks 221 according to the division information table, and displays all the blocks on the display unit 10. In the embodiment, the page layout of the page may be portrait or horizontal (landscape), portrait means the contents on the page will be are in portrait layout, and the horizontal type means that the contents on the page will be in horizontal layout. For example, in the portrait layout, the texts are generally read from right to left in vertical columns (see FIG. 4). In the horizontal layout, the texts are generally read from left to right in horizontal rows (see FIG. 5). In an embodiment, data in the division information table is preset by the manufacturer. This data defines the quantity of blocks a page needs to be divided into, and the size and position of each block. In an alternative embodiment, the data in the division information table is amended or added to by the user who, via the menu button, invokes a programming function to allow the input of data by the user into the division information table. A dialogue box is displayed when the user selects the programming function to facilitate the input of data by the user.

The acquisition module 31 receives inputs from the direction button 41, and reads a particular block 221 of the page where the cursor has been stopped according to a confirm signal from the confirm button 42. The display module 33 displays the particular block 221 on the display unit 10 with a magnified size. The size of magnification of the block may be set by default or is modifiable by the user. One particular magnification setting is that the particular block 221 occupies the whole screen.

Referring to FIG. 4, the contents of the displayed page are in portrait layout. In the embodiment, the page is divided into 9 blocks in a 3*3 matrix. Blocks 1-3 constitute a first column, blocks 4-6 constitute a second column and blocks 7-9 constitute a third column. Block 1, 4 and 7 constitute a first row, blocks 2, 5 and 8 constitute a second row and blocks 3, 6 and 9 constitute a third row, block N (N is an integer from 2to 9 inclusive) which immediately follows block (N−1). Referring to FIG. 5, the contents of the displayed page are in horizontal layout. In the embodiment, the page is also divided into 9 blocks in a 3*3 matrix. Blocks 1-3 constitute a first row, blocks 4-6 constitute a second row and blocks 7-9 constitute a third row. Block 1, 4 and 7 constitute a first column, blocks 2, 5 and 8 constitute a second column and blocks 3, 6 and 9 constitute a third column, block N (N is an integer from 2 to 9 inclusive) which immediately follows block (N−1). More particularly, in both FIGS. 4 and 5, the first few lines of block N repeat the last few lines of N−1, that is the first few contents of block N repeat the last few contents of N−1.

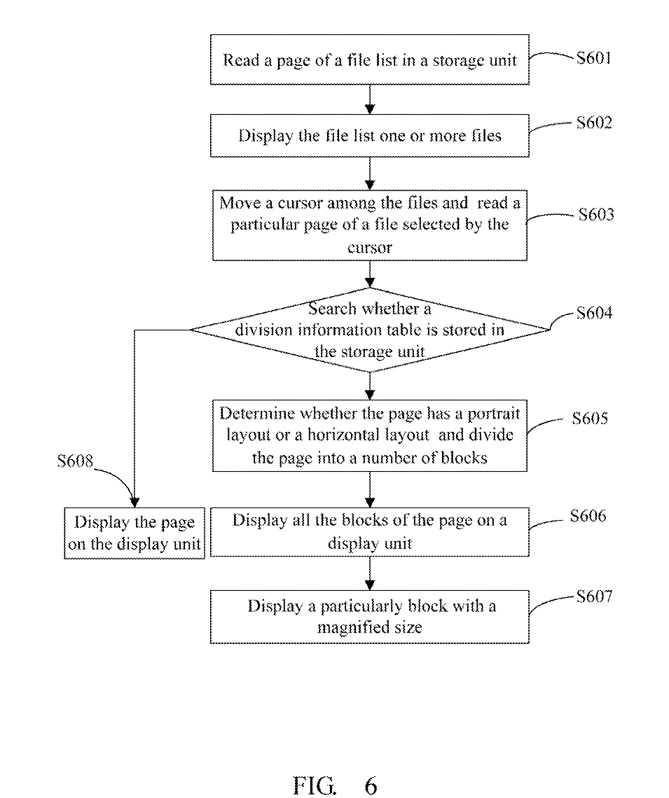

FIG. 6 shows a page display method of the electronic device 100 in accordance with an exemplary embodiment.

In step S601, an acquisition module 304 reads a file list in a storage unit 20 when a reading mode command is input into the electronic device 100.

In step S602, a display module 33 displays the file list of one or more files.

In step S603, the direction button 41 moves a cursor among the files and the acquisition module 31 reads a particular page of a selected file according to a confirm signal from a confirm button.

In step S604, a division module 32 searches the storage unit 20 for a division information table, if no division information table is found the program will go to step S608, if the division information table is found, the program will go to step S605.

In step S605, the division module 32 determines whether the page has a portrait layout or a horizontal layout according to the page properties, and divides the page into a number of blocks 221 according to the division information table if a division information table has been found. The division information table records information such as the number of blocks that a page needs to be divided into, and the size and position of each block.

In step S606, a display module 33 displays all the blocks of the page on the display unit 10.

In step S607, the display module 33 further displays a particular block 221 with a magnified size on the display unit 10 in response to a block select signal from the user. The display size of magnification may be set by default or is modifiable by the user.

In step S608, a display module 33 displays the complete page if no division information table is found in the storage unit.

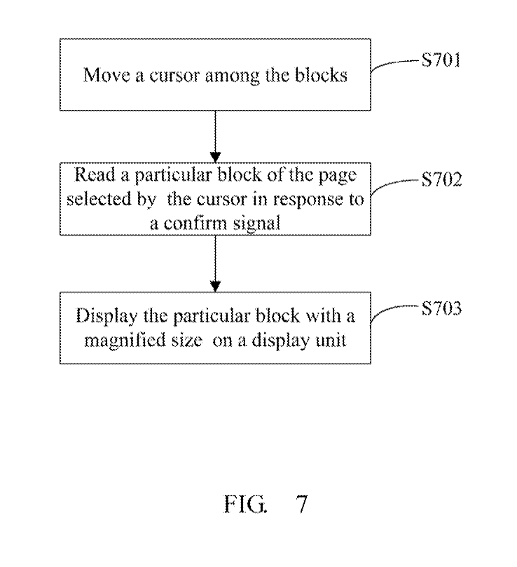

Referring to FIG. 7, step S607 comprises:

In step S701, the direction button 41 moves a cursor among the blocks 221.

In step S702, the acquisition module 31 reads a selected block 221 of the page selected by the cursor in response to a confirm signal from the confirm button 42.

In step S703, the display module 33 displays the selected block 221 in a magnified size on the display unit 10. A preset display proportion may be set by default or is modifiable by the user.

In the embodiment, the display module 33 returns to a previous display in response to a return signal from the return button 43 click by a user.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
a storage unit configured for storing files and a division information table;
an input unit configured for generating input signals in response to user's input operations;
a display unit configured for displaying information; and
a processing unit configured for:
controlling the electronic device to enter into a reading mode;
controlling the display unit to display a page of a file;
determining whether the page has a portrait layout or a horizontal layout according to the properties of the page;
dividing the page into a plurality of blocks according to a division information table;
controlling the display unit to display all the blocks thereon; and
displaying a selected block of the page with a magnified display size according to an input signal from the user.

2. The electronic device as claimed in claim 1, wherein the magnified display size of the selected block is set by default or is modifiable by the user.

3. The electronic device as claimed in claim 1, wherein the division information table includes information defining the number of blocks of a page needs to be divided into, and the size and position of each block after division.

4. The electronic device as described in claim 1, wherein the processing unit is configured for controlling the display unit to display a file list listing one or more files in response to the user's input operations, and controlling movement of a cursor among the files and reading a page of a file selected by the cursor in response to a confirm signal from the input unit.

5. The electronic device as described in claim 1, wherein the processing unit is configured for dividing the page into nine blocks in a 3×3 matrix for a user to select a block.

6. The electronic device as described in claim 1, wherein the processing unit is configured for controlling movement of a cursor among the blocks according to the user's input operation, and reading a block of the page selected by the cursor.

7. The electronic device as described in claim 1, wherein the processing unit is configured for controlling the display unit to display the selected block in full screen mode.

8. A page display method comprising:
displaying a page of a file on a display unit;
determining whether the page has a portrait layout or a horizontal layout according to a page property of the page;
dividing the page into a plurality of blocks according to a division information table;
displaying the blocks on the display unit; and
displaying a particular block of the blocks with an enlarged size on the display unit according to an selection signal input by a user.

9. The method as described in claim 8, wherein the page is divided into nine blocks in a 3×3 matrix.

10. The method as described in claim 8, further comprising:
displaying a file list listing one or more files according to the user's input operations;
moving a cursor among the files; and
reading a page of a file selected by the cursor according to a confirm signal from the input unit.

11. The method as described in claim 8, wherein the step of displaying a particular block comprises:
moving a cursor among the blocks to select a block according to the input operations by a user;
reading a selected block; and
displaying the selected block on the display unit with a magnified size.

12. The method as described in claim 9, further comprising:
returning to a previous displayed screen in response to a return button click by a user.
